(19) United States
(12) Patent Application Publication
(10) Pub. No.: US 2026/0238411 A1
(43) Pub. Date: Aug. 13, 2026

(54) RESOURCE ALLOCATION IN TIME/FREQUENCY DOMAINS FOR SBFD OPERATION

(71) Applicant: Apple Inc., Cupertino, CA (US)

(72) Inventors: Seyed Ali Akbar FAKOORIAN, San Diego, CA (US); Wei ZENG, Saratoga, CA (US); Dawei ZHANG, Saratoga, CA (US); Hong HE, San Jose, CA (US)

(21) Appl. No.: 19/156,546

(22) PCT Filed: Feb. 13, 2024
(86) PCT No.: PCT/US2024/015568

§ 371 Date: Aug. 14, 2025

Related U.S. Application Data
(60) Provisional application No. 63/445,706, filed on Feb. 14, 2023.

(51) Int. Cl. H04L 5/00; H04L 27/26; H04W 72/0453

(52) U.S. Cl. CPC H04L 5/0044; H04L 27/2656; H04W 72/0453

(57) ABSTRACT

Methods and systems are disclosed to enhance allocation and use of frequency and time domain resources to support uplink (UL) transmissions and downlink (DL) receptions by UE across sub-band frequency duplex (SBFD) symbols and non-SBFD symbols when the base station dynamically switches between half-duplex TDD and full-duplex FDD operations. UE may align the frequency resources configured for receiving DL referenced signals carried on non-SBFD symbols to the DL frequency sub-bands of SBFD symbols. Frequency domain resource allocation (FDRA) may group frequency resources used for transmitting DL user data based on the size of the concatenation of the two DL sub-bands of SBFD symbols. The nominal size of precoding resource block group (PRG) may also be based on the size of the concatenation of the two DL sub-bands of SBFD symbols. UE may implement capabilities to respond to time-domain resources scheduled for UL and DL transmissions across SBFD and non-SBFD symbols.

### FIELD OF INVENTION

This invention relates generally to the field of wireless communication, and more particularly, to systems and methods for time and frequency resource allocations for a mobile wireless device to operate in a half-duplex mode when communicating with a base station of a wireless communication network in which the base station operates a full-duplex mode within a time division duplexing (TDD) band. Other aspects are also described.

### BACKGROUND OF THE INVENTION

Wireless communications networks operating in TDD mode time-multiplexes downlink base-station-to-wireless-device communication and uplink wireless-device-to-base-station communication. For example, TDD mode as a half-duplex operation may be implemented between the base station and the UE (also referred to as user equipment or UE) by partitioning communication intervals into time slots in which each slot includes a downlink portion separated in time by a guard band from an uplink portion. Enhancements to TDD operation have been proposed to add the capability to switch the base station to operate in full-duplex mode within a TDD band by mixing frequency division duplex (FDD) and TDD symbols within a slot or by mixing FDD slots and TDD slots. In this configuration, the base station may simultaneously transmit to a first group of UEs while receiving from a second group of UEs using the FDD symbols or slots. However, a given UE is assumed to operate in the half-duplex mode by either transmitting or receiving, but not both simultaneously.

To support a mix of FDD symbols/slots (also referred to as sub-band frequency duplex (SBFD) symbols/slots) and TDD symbols/slots (also referred to as non-SBFD or legacy symbols/slots), UE may need to enhance frequency-domain resources that have been allocated for legacy symbols so that the frequency resources can be used by SBFD symbols. For example, the downlink frequency sub-band and the uplink frequency sub-band in SBFD symbols are different from the downlink bandwidth part (BWP) and uplink BWP of non-SBFD symbols. The result is that boundaries of frequency resources and reporting sub-bands may not be aligned between SBFD and non-SBFD symbols. If not enhanced, frequency resources configured for non-SBFD symbols may go beyond indicated sub-bands in SBFD symbols. UE operation in the time-domain to support downlink and uplink communication across SBFD and non-SBFD symbols in a slot may also introduce complexities. As such, it is desired to enhance resource allocation in the frequency and time domains to support UE operations across SBFD and non-SBFD symbols or slots.

### SUMMARY OF THE DESCRIPTION

Methods and systems are disclosed to enhance allocation and use of frequency-domain and time-domain resources to support uplink transmissions and downlink receptions by UE across sub-band frequency duplex (SBFD) symbols and non-SBFD symbols. UE may transmit or receive SBFD symbols or slots when the base station switches to FDD mode within a TDD band. Even though the base station is in full-duplex operation to transmit and receive simultaneously, the UE remains in half-duplex operation to either transmit or receive. Because the base station switches to full-duplex operation, frequency and time domain resources that are allocated for transmission or reception of legacy half-duplex non-SBFD symbols may no longer be available for use by SBFD symbols. For example, frequency resources in the downlink bandwidth part (BWP) and uplink BWP allocated for transmitting or receiving non-SBFD symbols by UE may no longer be available for transmitting or receiving SBFD symbols using the smaller downlink frequency sub-band and the smaller uplink frequency sub-band. Conversely, time-domain resources scheduled for transmitting or receiving symbols in a SBFD slot by UE may not be available for transmitting or receiving symbols in a non-SBFD slot because the scheduled time for transmitting/receiving a symbol in the SBFD slot may be used for receiving/transmitting a symbol in the non-SBFD slot. Enhancements to the allocation of frequency and time resources are presented to allow UE to seamlessly work across SBFD and non-SBFD symbols when the base station dynamically switches between FDD and TDD operations.

In one aspect, frequency resources of non-SBFD symbols carrying downlink reference signals configured for measurements of channel characteristics by the UE may not be fully used by the UE for channel measurements when the downlink reference signals are received in SBFD symbols. In non-SBFD symbols (legacy TDD symbols), downlink frequency resources are allocated on downlink BWP and uplink frequency resources are allocated on uplink BWP. In SBFD symbols, frequency resources are partitioned into those used for downlink and uplink. For example, frequency resources may include two outer downlink frequency sub-bands each separated by a guard band from an inner uplink frequency sub-band.

In one embodiment, frequency resource configuration for the downlink reference signals is common between non-SBFD symbols and SBFD symbols. The UE may align the frequency resources configured on downlink BWP of non-SBFD symbols for receiving the downlink referenced signals to the downlink frequency sub-bands of SBFD symbols. The UE may ignore the frequency resources that lie in the uplink frequency sub-band or the guard bands when receiving the downlink reference signals to measure characteristics of the downlink channels. The UE may receive the downlink reference signals on one or both of the downlink frequency sub-bands. The UE may report the channel measurements on a single report to the base station.

In one embodiment, frequency resources for the downlink reference signals are configured separately for SBFD symbols from the non-SBFD symbols to provide extra flexibility at a slight increase in configuration overhead. Two frequency resources may be configured, one for each of the two downlink frequency sub-bands. The UE may receive the downlink reference signals on the two downlink frequency sub-bands to measure the channels. In one embodiment, the UE may report the channel measurements on a single report by treating the frequency resources on the two downlink frequency sub-bands as a single frequency resource. In one embodiment, the UE may report the channel measurements separately for the reference signals on the two downlink frequency sub-bands.

In one aspect, frequency domain resource allocation (FDRA) may group frequency resources used for transmitting downlink user application data differently between SBFD and non-SBFD symbols. Contiguous frequency resources in the downlink BWP for non-SBFD symbols may be grouped into resource block groups (RBG) so that downlink frequency resources may be allocated in quantum of RBG. The nominal size of each RBG may be a function of the size of the downlink BWP. Allocation of downlink frequency resources in units of RBG may be specified using a bitmap, with each bit of the bitmap corresponding to each RBG.

In one embodiment, for SBFD symbols, the nominal size of each RBG may be a function of the size of the concatenation of the two downlink frequency sub-bands. Because the size of the concatenation of the two downlink frequency sub-bands in SBFD symbols is smaller than the size of the BWP in non-SBFD symbols, the nominal size of each RBG for the SBFD symbols may be smaller than that of non-SBFD symbols, allowing for more granularity when allocating downlink frequency resources. The size of the bitmap used to allocate the RGBs for downlink data may also be smaller than that of non-SBFD symbols. RBG may not lie within the uplink frequency sub-band or the guard bands of SBFD symbols so that actual RBGs at the edge of the downlink frequency sub-bands allocated for downlink data transmission as indicated by the bitmap may be smaller than the nominal size of the RBG.

In one embodiment, the nominal size of each RBG in SBFD symbols may be a function of the size of the downlink BWP as in non-SBFD symbols. The RGB allocation bitmap may not be allowed to allocate RGBs that fully lie in the uplink frequency sub-band or the guard bands. In one embodiment, for RGBs that partially overlap with the guard bands or the uplink frequency sub-band, the entire RBGs allocated by the allocation bitmap are dropped. In one embodiment, actual RBGs at the edge of the downlink frequency sub-bands allocated for downlink data transmission as indicated by the allocation bitmap may be smaller than the nominal size of the RBG so that the allocated frequency resources only lie within the downlink frequency sub-bands.

In one aspect, frequency resources may be bundled to allow the UE to assume that all frequency resources within a bundle experience a similar propagation channel. For example, precoding resource block group (PRG) is a set of contiguous resource blocks of frequency resources from which the UE may generate a single channel estimate. The resource blocks belonging to a PRG are assumed to experience similar channel conditions and have the same precoding applied by the base station. In one embodiment, for bundling frequency resources used for transmitting downlink data within SBFD symbols, the nominal PRG size may be a function of the size of the concatenation of the two downlink frequency sub-bands.

In one embodiment, the nominal PRG size for transmitting downlink data within SBFD symbols is a function of the size of the downlink BWP as in non-SBFD symbols. As in RBG, PRG may not lie within the uplink frequency sub-band or the guard bands of SBFD symbols. In one embodiment, actual PRGs at the edge of the downlink frequency sub-bands may be smaller than the nominal PRG size so that the bundled resource blocks only lie within the downlink frequency sub-bands.

In one aspect, UE may implement capabilities to respond to time-domain resources scheduled for transmitting uplink signals across SBFD and non-SBFD symbols. For example, the base station may schedule an uplink transmission occasion for UE to transmit uplink user data, uplink control messages, uplink reference signals used by the base station to measure uplink propagation channel, random access request, etc. The uplink transmission occasion within a time slot may span in time SBFD and non-SBFD symbols.

In one embodiment, all SBFD and non-SBFD symbols in the uplink transmission occasion may span the same frequency resources and UE may apply a single transmission power to all the symbols. In one embodiment, UE may be indicated by the base station to apply a different or reduced power on SBFD symbols to reduce cross-channel interference between multiple UEs transmitting over the uplink frequency sub-band. In one embodiment, UE may not expect the scheduled uplink transmission occasion to span in time both SBFD and non-SBFD symbols.

In one aspect, UE may implement capabilities to respond to multiple repetitions of an uplink transmission occasion within a time slot or across multiple time slots when the multiple uplink transmission occasions include both SBFD symbols and non-SBFD symbols. In one embodiment, if the first uplink repetition occasion is scheduled within SBFD symbols and a subsequent uplink repetition occasion includes non-SBFD symbols, the UE may drop the subsequent uplink repetition occasion.

In one embodiment, if the first uplink repetition occasion is scheduled within SBFD symbols and a subsequent uplink repetition occasion includes non-SBFD uplink symbols or symbols that may be configured for uplink transmission, and if the uplink BWP of the non-SBFD symbols and the uplink frequency sub-band of the SBFD symbols have the same size, the UE may use the subsequent uplink repetition occasion. In one embodiment, if the first uplink repetition occasion is scheduled within SBFD symbols and a subsequent uplink repetition occasion includes non-SBFD uplink symbols or symbols that may be configured for uplink transmission, and if the allocated uplink frequency resources of the SBFD symbols fit within the uplink BWP of the non-SBFD symbols, the UE may use the subsequent uplink repetition occasion.

In one embodiment, if the first uplink repetition occasion is scheduled within non-SBFD symbols and a subsequent uplink repetition occasion includes SBFD symbols, the UE may drop the subsequent repetition occasion. In one embodiment, if the first uplink repetition occasion is scheduled within non-SBFD symbols and a subsequent uplink repetition occasion includes SBFD symbols, and if the uplink BWP of the non-SBFD symbols and the uplink frequency sub-band of the SBFD symbols have the same size, the UE may use the subsequent uplink repetition occasion. In one embodiment, if the first uplink repetition occasion is scheduled within non-SBFD symbols and a subsequent uplink repetition occasion includes SBFD symbols, and if the allocated uplink frequency resources of the SBFD symbols fit within the uplink BWP of the non-SBFD symbols, the UE may use the subsequent repetition occasion. In one embodiment, an uplink repetition occasion of SBFD symbols within a slot may be transmitted using a different or reduced power relative to the transmission power of non-SBFD symbols.

In one aspect, the UE may implement capabilities to respond to time-domain resources scheduled for transmitting downlink signals across SBFD and non-SBFD symbols. For example, the base station may schedule a downlink transmission occasion for UE to receive downlink user data, downlink control messages, downlink reference signals, etc. The downlink transmission occasion within a time slot may span in time SBFD and non-SBFD symbols.

In one embodiment, all SBFD and non-SBFD symbols in the downlink transmission occasion may span the same frequency resources. The UE may assume that the base station applies the same transmit power and the same number of antenna ports to transmit the SBFD and non-SBFD symbols, and that the downlink channels of the SBFD and non-SBFD symbols share common characteristics, although the base station may transmit the SBFD symbols using a different (e.g., reduced) antenna gain in comparison to the non-SBFD symbols. In this embodiment, the UE may receive the downlink transmission occasion. In one embodiment, the UE may not expect the scheduled downlink transmission occasion to span in time both SBFD and non-SBFD symbols.

In one aspect, UE may implement capabilities to respond to multiple repetitions of a downlink transmission occasion within a time slot or across multiple time slots when the multiple downlink transmission occasions include both SBFD symbols and non-SBFD symbols. In one embodiment, if the first downlink repetition occasion is scheduled within SBFD symbols and a subsequent downlink repetition occasion includes non-SBFD symbols, the UE may receive the subsequent repetition occasion subject to the condition the base station applies the same transmit power and the same number of antenna ports to transmit the SBFD and non-SBFD symbols, and that the downlink channels of the SBFD and non-SBFD symbols share common characteristics.

In one embodiment, if the first downlink repetition occasion is scheduled within non-SBFD symbols and a subsequent downlink repetition occasion includes non-SBFD symbols, the UE may drop the subsequent repetition occasion. In one embodiment, if the first downlink repetition occasion is scheduled within non-SBFD symbols and a subsequent downlink repetition occasion includes SBFD symbols, and if the allocated downlink frequency resources in the downlink BWP of the non-SBFD symbols fit within the downlink frequency sub-band of the SBFD symbols, the UE may receive the subsequent repetition occasion subject to the condition the base station applies the same transmit power and the same number of antenna ports to transmit the SBFD and non-SBFD symbols, and that the downlink channels of the SBFD and non-SBFD symbols share common characteristics.

### BRIEF DESCRIPTION OF THE DRAWINGS

The present invention is illustrated by way of example and not limitation in the figures of the accompanying drawings in which like references indicate similar elements.

FIG. 1 illustrates an example wireless communication system according to one aspect of the disclosure.

FIG. 2 illustrates user equipment in direct communication with a base station (BS) according to one aspect of the disclosure.

FIG. 3 illustrates an example block diagram of a UE according to one aspect of the disclosure.

FIG. 4 illustrates an example block diagram of a BS according to one aspect of the disclosure.

FIG. 5 illustrates an example block diagram of cellular communication circuitry according to one aspect of the disclosure.

FIG. 6 illustrates the frequency resources of a TDD slot used for transmission and reception of legacy TDD symbols compared to the frequency resources of a FDD slot used for transmission and reception of SBFD symbols, according to one aspect of the disclosure.

FIG. 7 illustrates a UE aligning frequency resources to receive downlink reference signals on one downlink frequency sub-band of SBFD symbols when the frequency resources that are commonly configured between non-SBFD and SBFD symbols lie in the uplink frequency sub-band or the guard band, according to one aspect of the disclosure.

FIG. 8 illustrates a UE aligning frequency resources to receive downlink reference signals on both downlink frequency sub-bands of SBFD symbols when the frequency resources that are commonly configured between non-SBFD and SBFD symbols lie in the uplink frequency sub-band or the guard band, according to one aspect of the disclosure.

FIG. 9 illustrates a UE receiving downlink reference signals on both downlink frequency sub-bands of SBFD symbols when the frequency resources for the downlink reference signals are configured separately between non-SBFD and SBFD symbols, according to one aspect of the disclosure.

FIG. 10 depicts a flowchart of a method for a UE to receive downlink reference signals transmitted in SBFD symbols and non-SBFD symbols when the UE receives information on frequency resources configured to carry the downlink reference signals, according to one aspect of the disclosure.

FIG. 11 illustrates frequency domain resource allocation for SBFD symbols where frequency resources used by UE to receive downlink transmissions are grouped into a nominal size determined based on an effective bandwidth that is the concatenation of the two downlink frequency sub-bands, according to one aspect of the disclosure.

FIG. 12 depicts a flowchart of a method for a UE to receive downlink transmissions on frequency resources in SBFD symbols and non-SBFD symbols when the frequency resources are grouped and allocated differently for the SBFD and non-SBFD symbols, according to one aspect of the disclosure.

FIG. 13 illustrates a UE transmitting an uplink transmission occasion that spans SBFD and non-SBFD symbols when all the symbols in the uplink transmission occasion spans the same frequency resources, according to one aspect of the disclosure.

FIG. 14 illustrates a UE transmitting multiple repetitions of an uplink transmission occasion across multiple slots of SBFD symbols and non-SBFD symbols when the first uplink repetition occasion is scheduled in a slot of SBFD symbols and a subsequent uplink repetition occasion includes a slot of non-SBFD symbols, according to one aspect of the disclosure.

FIG. 15 illustrates a UE transmitting multiple repetitions of an uplink transmission occasion across multiple slots of SBFD symbols and non-SBFD symbols when the first uplink repetition occasion is scheduled in a slot of non-SBFD symbols and subsequent uplink repetition occasions include slots of non-SBFD symbols, according to one aspect of the disclosure.

FIG. 16 illustrates a UE receiving a downlink transmission occasion that spans SBFD and non-SBFD symbols when all the symbols in the downlink transmission occasion spans the same frequency resources, according to one aspect of the disclosure.

FIG. 17 illustrates a UE receiving multiple repetitions of a downlink transmission occasion across multiple slots of SBFD symbols and non-SBFD symbols when the first downlink link repetition occasion is scheduled in a slot of SBFD symbols and subsequent downlink repetition occasions include slots of non-SBFD symbols, according to one aspect of the disclosure.

FIG. 18 illustrates a UE receiving multiple repetitions of a downlink transmission occasion across multiple slots of SBFD symbols and non-SBFD symbols when the first downlink link repetition occasion is scheduled in a slot of non-SBFD symbols and subsequent downlink repetition occasions include slots of SBFD symbols, according to one aspect of the disclosure.

FIG. 19 depicts a flowchart of a method for a UE to transmit on uplink transmission occasions when the uplink transmission occasions include time and frequency resources allocated for transmitting SBFD and non-SBFD symbols, according to one aspect of the disclosure.

FIG. 20 depicts a flowchart of a method for a UE to receive on downlink transmission occasions when the downlink transmission occasions include time and frequency resources allocated for receiving SBFD and non-SBFD symbols, according to one aspect of the disclosure.

### DETAILED DESCRIPTION

Methods and systems are disclosed to enhance allocation and use of frequency-domain and time-domain resources to support uplink transmissions and downlink receptions by UE across sub-band frequency duplex (SBFD) symbols and non-SBFD symbols when the base station dynamically switches between half-duplex TDD operation and full-duplex FDD operation that uses frequency sub-bands of the TDD band.

In one aspect, a method for operating a UE to receive transmissions from a base station of a communication network includes a first interval in which the base station transmits on a downlink bandwidth without simultaneously receiving, and a second interval in which the base station simultaneously transmits on a downlink frequency sub-band and receives on an uplink frequency sub-band. The downlink bandwidth is selected to encompass the downlink frequency sub-band and the uplink frequency sub-band. The UE receives from the base station frequency-domain configuration used to configure the UE to receive reference signals transmitted by the base station during the first interval. The UE determines frequency-domain resources used to receive the reference signals during the second interval based on the frequency-domain configuration, information on the downlink bandwidth, and information on the downlink frequency sub-band. The UE receives the reference signals transmitted by the base station on the downlink frequency sub-band during the second interval based on the determined frequency-domain resources.

In one aspect, a method for operating a UE to receive transmissions from a base station of a communication network includes a first interval in which the base station transmits on a downlink bandwidth without simultaneously receiving, and a second interval in which the base station simultaneously transmits on a downlink frequency sub-band and receives on an uplink frequency sub-band. The downlink bandwidth is selected to encompass the downlink frequency sub-band and the uplink frequency sub-band. The UE receives from the base station configuration information that is used with information on the downlink bandwidth to allocate first frequency-domain resources used by the UE to receive transmissions from the base station during the first interval. The UE determines second frequency-domain resources used to receive transmissions from the base station during the second interval based on the configuration information used to allocate the first frequency-domain resources and information on the downlink frequency sub-band. The UE receives the transmissions from the base station on the downlink frequency sub-band during the second interval based on the second frequency-domain resources.

In one aspect, a method for operating a UE to communicate with a base station of a communication network includes a first interval and a second interval. During the first interval, the base station transmits to the UE on a downlink bandwidth or receives from the UE on an uplink bandwidth without overlapping in time. During the second interval, the base station simultaneously receives from the UE on an uplink frequency sub-band and transmits to one or more other UEs on a downlink frequency sub-band. The UE receives from the base station scheduling information to schedule the UE to transmit to the base station using allocated frequency resources over one or more scheduled intervals that span the first interval and the second interval. The UE determines time-domain resources used to transmit during the first interval and the second interval based on the scheduled intervals, the uplink bandwidth, the uplink frequency sub-band, the first interval, and the second interval. The UE transmits to the base station over the allocated frequency resources during the first interval and the second interval using the time-domain resources.

In one aspect, a method for operating a UE to communicate with a base station of a communication network includes a first interval and a second interval. During the first interval, the base station transmits to the UE on a downlink bandwidth or receives from the UE on an uplink bandwidth without overlapping in time. During the second interval, the base station simultaneously receives from the UE on an uplink frequency sub-band and transmits to one or more other UEs on a downlink frequency sub-band. The UE receives from the base station scheduling information to schedule the UE to receive from the base station using allocated frequency resources over one or more scheduled intervals that span the first interval and the second interval. The UE determines time-domain resources used to receive during the first interval and the second interval based on the scheduled intervals, the downlink bandwidth, the downlink frequency sub-band, the first interval, and the second interval. The UE receives from the base station over the allocated frequency resources during the first interval and the second interval using the time-domain resources.

In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “some embodiments” or “an embodiment” means that a particular feature, structure, or characteristic described in connection with the embodiment can be included in at least one embodiment of the invention. The appearances of the phrase “in some embodiments” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

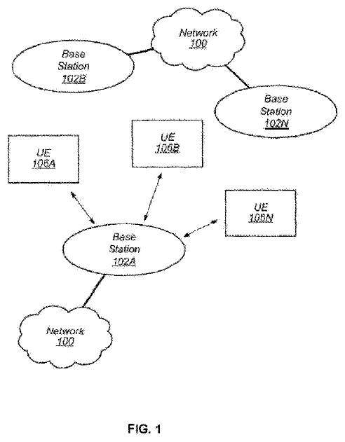

FIG. 1 illustrates a simplified example wireless communication system according to one aspect of the disclosure. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP 2 CDMA 2000 (e.g., 1xRTT, 1xEV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP 2 CDMA 2000 (e.g., 1xRTT, 1xEV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

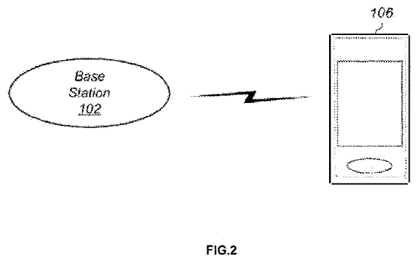

FIG. 2 illustrates a UE 106 in direct communication with a base station 102 through uplink and downlink communications according to one aspect of the disclosure. The UE 106 may be a device with cellular communication capability such as a mobile phone, a hand-held device, a computer or a tablet, or virtually any type of wireless device. The UE 106 may include a processor that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array) that is configured to perform any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, CDMA2000 (1xRTT/1xEV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1xRTT or LTE or GSM), and separate radios for communicating using each of Wi-Fi and Bluetooth. Other configurations are also possible.

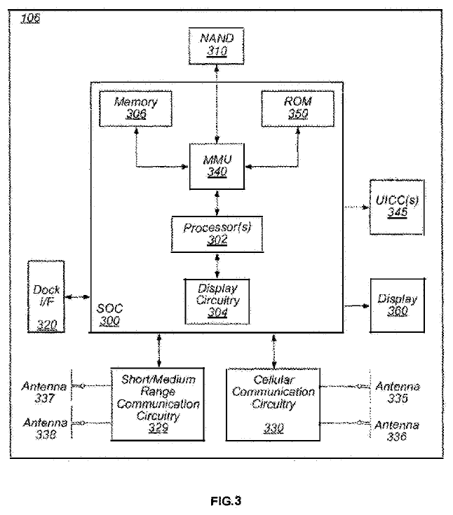

FIG. 3 illustrates an example simplified block diagram of a communication device 106 according to one aspect of the disclosure. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, communication device 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly. dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. The communication device 106 may also be configured to determine a physical downlink shared channel scheduling resource for a user equipment device and a base station. Further, the communication device 106 may be configured to group and select CCs (component carriers) from the wireless link and determine a virtual CC from the group of selected CCs. The wireless device may also be configured to perform a physical downlink resource mapping based on an aggregate resource matching patterns of groups of CCs.

As described herein, the communication device 106 may include hardware and software components for implementing the above features for determining a physical downlink shared channel scheduling resource for a communications device 106 and a base station. The processor 302 of the communication device 106 may be configured to implement part or all of the features described herein, e.g., by executing program instructions stored on a memory medium (e.g., a non-transitory computer-readable memory medium). Alternatively, (or in addition), processor 302 may be configured as a programmable hardware element, such as an FPGA (Field Programmable Gate Array), or as an ASIC (Application Specific Integrated Circuit). Alternatively, (or in addition), the processor 302 of the communication device 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, cellular communication circuitry 330 and short-range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, etc.) configured to perform the functions of cellular communication circuitry 230. Similarly, the short-range wireless communication circuitry 329 may include one or more ICs that are configured to perform the functions of short-range wireless communication circuitry 32. In addition, each integrated circuit may include circuitry (e.g., first circuitry, second circuitry, etc.) configured to perform the functions of short-range wireless communication circuitry 329.

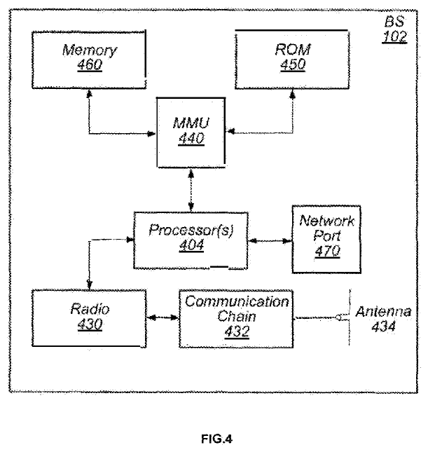

FIG. 4 illustrates an example block diagram of a base station 102 according to one aspect of the disclosure. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UEs 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UEs 106. In some cases, the network port 470 may couple to a telephone network via the core network, and/or the core network may provide a telephone network (e.g., among other UEs serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UEs 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively, (or in addition), the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

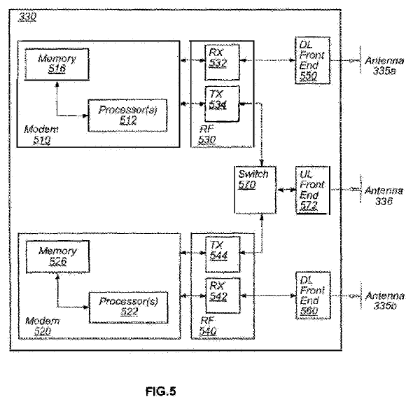

FIG. 5 illustrates an example simplified block diagram of cellular communication circuitry according to one aspect of the disclosure. It is noted that the block diagram of the cellular communication circuitry of FIG. 5 is only one example of a possible cellular communication circuit. According to embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335 a-b and 336 as shown (in FIG. 3). In some embodiments, cellular communication circuitry 330 may include dedicated receive chains (including and/or coupled to, e.g., communicatively; directly or indirectly. dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for selecting a periodic resource part for a user equipment device and a base station, as well as the various other techniques described herein. The processors 512 may be configured to implement part or all of the features described herein, e.g., by executing program instructions stored on a memory medium (e.g., a non-transitory computer-readable memory medium). Alternatively, (or in addition), processor 512 may be configured as a programmable hardware element, such as an FPGA (Field Programmable Gate Array), or as an ASIC (Application Specific Integrated Circuit). Alternatively, (or in addition), the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, etc.) configured to perform the functions of processors 512.

As described herein, the modem 520 may include hardware and software components for implementing the above features for selecting a periodic resource on a wireless link between a UE and a base station, as well as the various other techniques described herein. The processors 522 may be configured to implement part or all of the features described herein, e.g., by executing program instructions stored on a memory medium (e.g., a non-transitory computer-readable memory medium). Alternatively, (or in addition), processor 522 may be configured as a programmable hardware element, such as an FPGA (Field Programmable Gate Array), or as an ASIC (Application Specific Integrated Circuit). Alternatively, (or in addition), the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, etc.) configured to perform the functions of processors 522.

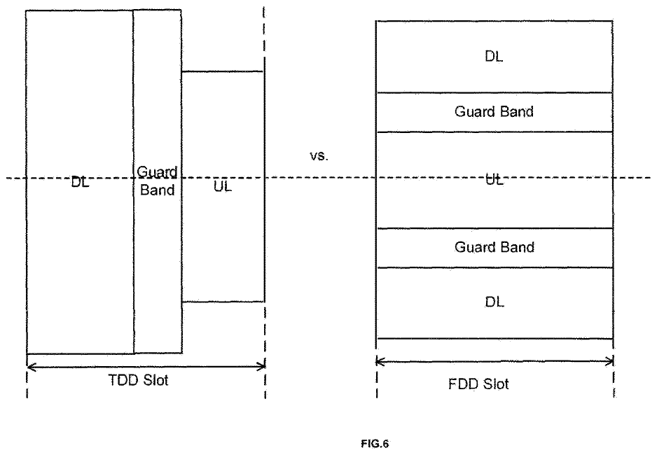

FIG. 6 illustrates the frequency resources of a TDD slot used for transmission and reception of legacy TDD symbols compared to the frequency resources of a FDD slot used for transmission and reception of SBFD symbols, according to one aspect of the disclosure.

The TDD slot includes a downlink portion (DL) separated in time by a guard band from an uplink (UL) portion. The TDD slot includes TDD symbols (also called non-SBFD symbols or legacy symbols). The DL transmission is carried on frequency resources allocated from the downlink bandwidth part (BWP) and the UL portion is carried on frequency resources allocated from the uplink BWP.

The FDD slot (also called SBFD slot) includes frequency resources that are partitioned into those used for downlink and uplink transmission of SBFD symbols. For example, frequency resources may include two outer downlink frequency sub-bands each separated by a guard band from an inner uplink frequency sub-band. The concatenation of the two downlink frequency sub-bands in the FDD slot is smaller than the size of the downlink BWP in the TDD slot. In one embodiment, the concatenation of the two downlink frequency sub-bands in the FDD slot may be the same as the size of the downlink BWP in the TDD slot. The size of the uplink frequency sub-band in the FDD slot is smaller than the size of the uplink BWP in the TDD slot. In one embodiment, the size of the uplink frequency sub-band in the FDD slot may be the same as the size of the uplink BWP in the TDD slot. The center of the downlink BWP and the uplink BWP of the TDD slot may be aligned with the center of the frequency resources of the FDD slot.

In one aspect, frequency resources of non-SBFD symbols carrying downlink reference signals such as channel state information reference signals (CSI-RS) configured for the UE to measure downlink channel characteristics may not be fully used by the UE when the downlink reference signals are received in SBFD symbols. In one embodiment, for CSI-RS resource configuration within SBFD symbols, the UE may be configured with a CSI-RS resource configuration that is common between legacy TDD and SBFD symbols with some modifications for reception of CSI-RS in SBFD symbols. For example, the number of ports (e.g., nrofPorts parameter in CSI-RS-ResourceMapping information element (IE) in 5G) may be different for TDD symbols because gNB may not be able to keep same number of Tx antennas for half-duplex operation in TDD symbols and full-duplex operation in SBFD symbols. In one embodiment, the new IE may include two values for nrofPorts parameters, one for TDD symbols and another one for SBFD symbols. In one embodiment, nrofPorts for CSI-RS within SBFD symbols is assumed to be a fraction (e.g., half) of the configured nrofPorts parameter (which is applicable to CSI-RS within TDD symbols).

The starting resource block (RB) of the CSI-RS within TDD symbols may be indicated by a parameter (e.g., startingRB parameter in CSI-FrequencyOccupation IE in 5G). The startingRB parameter is reference in relation to common resource block #0 (CRB#0). In one embodiment, for SBFD symbols, if the starting resource block lies in UL frequency sub-band or guard-band, the UE may assume that the initial CRB index of the CSI-RS resource is moved to the first physical resource block (PRB) of the upper DL frequency sub-band that starts at a PRB larger than the starting resource block.

The number of resource blocks of the CSI-RS within TDD symbols may be indicated by a parameter (e.g., nrofRBs parameter in CSI-FrequencyOccupation IE in 5G). In one embodiment, if the starting resource block plus the number of resource blocks of the CSI-RF exceeds the upper DL frequency sub-band (or alternatively DL BWP) of SBFD symbols, the UE may assume that the ending PRB associated with the CSI-RS bandwidth is the end of upper DL frequency sub-band (or alternatively the end of DL BWP). In one embodiment, CSI-RS RBs that lie in UL frequency sub-band or guard bands are not considered for CSI-RS reception. Thus, the UE may align the frequency resources configured on downlink BWP of non-SBFD symbols to the downlink frequency sub-bands of SBFD symbols. In one embodiment, it is assumed that if the CSI-RS resource spans more than one symbol, all symbols are legacy TDD or all are SBFD. The UE may receive the CSI-RS on one or both of the downlink frequency sub-bands to measure the channels. The UE may report the channel measurements on a single report to the base station.

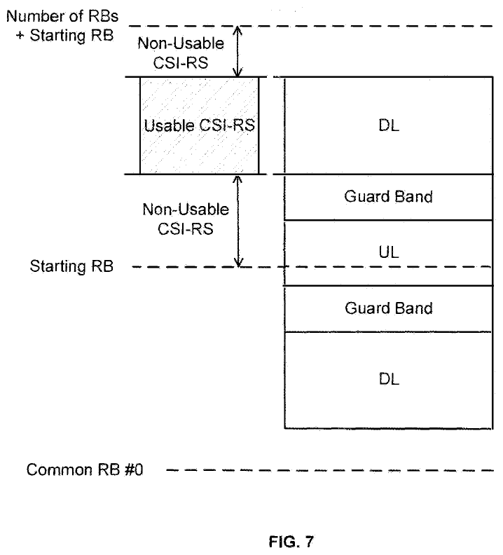

FIG. 7 illustrates a UE aligning frequency resources to receive downlink reference signals on one downlink frequency sub-band of SBFD symbols when the frequency resources that are commonly configured between non-SBFD and SBFD symbols lie in the uplink frequency sub-band or the guard band, according to one aspect of the disclosure. The starting RB relative to the common RB#0 lies in the UL frequency sub-band. The starting resource block plus the number of resource blocks of the CSI-RF exceeds the upper DL frequency sub-band. The UE moves the initial CRB index of the CSI-RS resource to the first PRB of the upper DL frequency sub-band. The UE also moves the end of the PRB associated with the CSI-RS bandwidth to the end of upper DL frequency sub-band. The CRS-RS resources that are in the UL frequency sub-band or the guard band are not used.

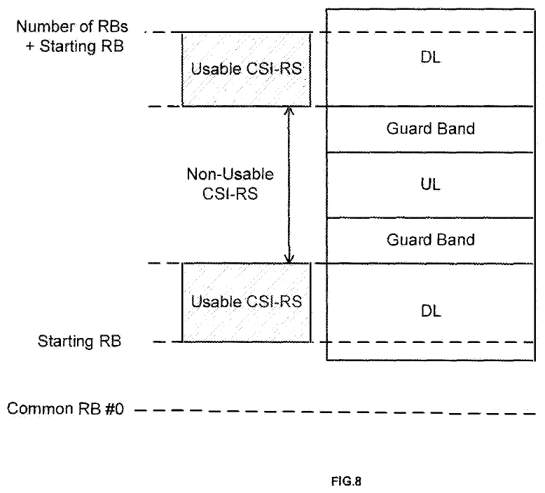

FIG. 8 illustrates a UE aligning frequency resources to receive downlink reference signals on both downlink frequency sub-bands of SBFD symbols when the frequency resources that are commonly configured between non-SBFD and SBFD symbols lie in the uplink frequency sub-band or the guard band, according to one aspect of the disclosure. The starting RB relative to the common RB#0 lies in the lower DL frequency sub-band. The starting resource block plus the number of resource blocks of the CSI-RF lies in the upper DL frequency sub-band. The CRS-RS resources that are in the UL frequency sub-band or the guard band are not used.

In one embodiment, frequency resources for the CSI-RS are configured separately for SBFD symbols from the non-SBFD symbols. Two separate CSI-RS frequency resources may be configured, one for each of the two downlink frequency sub-bands. In one embodiment, the two CSI-RS resources may have independent parameters. In one embodiment, some parameters may be common (e.g., frequencyDomainAllocation, nrofPorts, firstOFDMSymbolInTimeDomain, cdm-Type, density in CSI-RS-ResourceMapping IE in 5G). In one embodiment, two starting RBs of the CSI-RS frequency resources may be configured (e.g., two startingRB parameters in CSI-FrequencyOccupation IE in 5G), each associated with one of the two downlink frequency sub-bands. In one embodiment, the number of RB may be commonly configured for the two downlink frequency sub-bands. In one embodiment, the number of RB may be separately configured for the two downlink frequency sub-bands.

The UE may receive the CSI-RS on the two downlink frequency sub-bands to measure the channels. In one embodiment, the UE may report the channel measurements on a single report. For example, if all parameters (except the starting RB and possibly the number of RB) are common between the two CSI-RS resources, CSI-RS measurement may be linked to a single report by treating the CSI-RS resources on the two downlink frequency sub-bands as a single resource. In one embodiment, the UE may report the channel measurements separately for the CSI-RS resources on the two downlink frequency sub-bands.

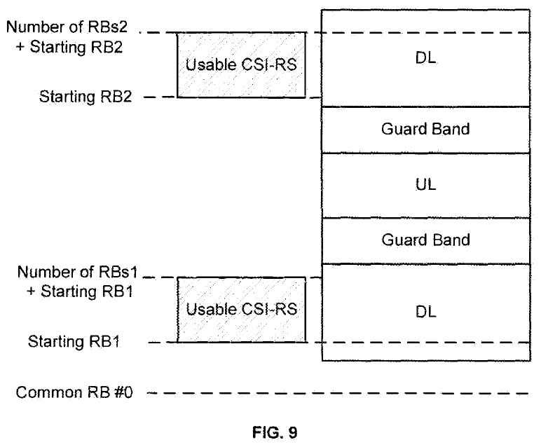

FIG. 9 illustrates a UE receiving downlink reference signals on both downlink frequency sub-bands of SBFD symbols when the frequency resources for the downlink reference signals are configured separately between non-SBFD and SBFD symbols, according to one aspect of the disclosure. The starting RB and the number of RB of the CSI-RS frequency resources for the lower DL frequency sub-band and the upper DL frequency sub-band is separately configured. The separate configuration provides extra flexibility at a slight increase in configuration overhead.

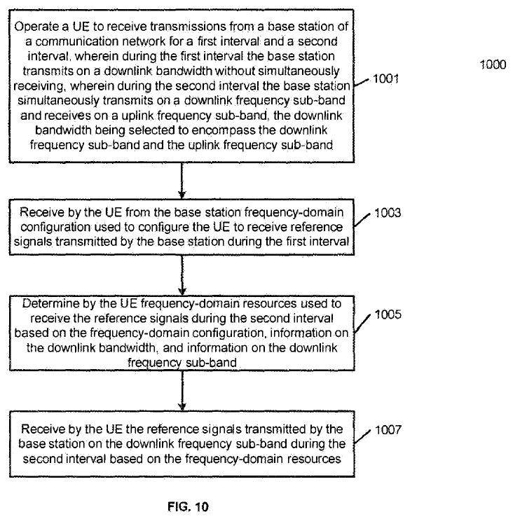

FIG. 10 depicts a flowchart of a method 1000 for a UE to receive downlink reference signals transmitted in SBFD symbols and non-SBFD symbols when the UE receives information on frequency resources configured to carry the downlink reference signals, according to one aspect of the disclosure.

In operation 1001, the UE receives transmissions from a base station of a communication network in a first interval and a second interval. During the first interval, the base statin transmits on a downlink bandwidth without simultaneously receiving. During the second interval, the base station simultaneously transmits on a downlink frequency sub-band and receives on an uplink frequency sub-band. The downlink bandwidth is selected to encompass the downlink frequency sub-band and the uplink frequency sub-band.

In operation 1003, The UE receives from the base station frequency-domain configuration used to configure the UE to receive reference signals transmitted by the base station during the first interval.

In operation 1005, the UE determines frequency-domain resources used to receive the reference signals during the second interval based on the frequency-domain configuration, information on the downlink bandwidth, and information on the downlink frequency sub-band.

In operation 1007, UE receives the reference signals transmitted by the base station on the downlink frequency sub-band during the second interval based on the determined frequency-domain resources.

In one aspect, frequency domain resource allocation (FDRA) may group frequency resources used for transmitting downlink user application data differently between SBFD and non-SBFD symbols. Contiguous RBs in the downlink BWP for non-SBFD symbols may be grouped into resource block groups (RBG) so that downlink frequency resources may be allocated in units of RBG. Two major FDRA schemes in 5G are Type 0 and Type 1. Type 0 is bitmap based (i.e., not necessarily consecutive allocation). Allocation of downlink frequency resources in units of RBG may be specified using the bitmap, with each bit of the bitmap corresponding to each RBG The nominal RBG size may be determined based on the active BWP part. Type 1 is consecutive based RB allocation, where downlink control information (DCI) may indicate the starting RB and the length of allocation.

In one embodiment, for FDRA of DL frequency resources for SBFD symbols, bitmap-based type 0 may be used. The nominal RBG size may be based on size of both DL frequency sub-bands, which is smaller than DL BWP size of non-SBFD symbols. For example, the nominal size of the RBG may be a function of the size of the concatenation of the two downlink frequency sub-bands, which may be considered an effective DL BWP for SBFD symbols. Because the size of the concatenation of the two downlink frequency sub-bands in SBFD symbols is smaller than the size of the BWP in non-SBFD symbols, the nominal size of the RBG for the SBFD symbols may be smaller than that of non-SBFD symbols, allowing for more granularity when allocating downlink frequency resources. The size of the bitmap used to allocate the RGBs for downlink data may also be smaller than that of non-SBFD symbols. RBG may not lie within the UL frequency sub-band or the guard bands of SBFD symbols so that actual RBGs at the edge of the DL frequency sub-bands allocated for DL data transmission as indicated by the bitmap may be smaller than the nominal size of the RBG.

In one embodiment, the nominal size of each RBG in SBFD symbols may be a function of the size of the downlink BWP as in non-SBFD symbols. The RGB allocation bitmap may not be allowed to allocate RGBs that fully lie in the UL frequency sub-band or the guard bands. In one embodiment, for RGBs that partially overlap with the guard bands or the UL frequency sub-band, the entire RBGs allocated by the allocation bitmap are dropped. In one embodiment, actual RBGs at the edge of the DL frequency sub-bands allocated for DL data transmission as indicated by the allocation bitmap may be smaller than the nominal size of the RBG so that the allocated frequency resources only lie within the DL frequency sub-bands.

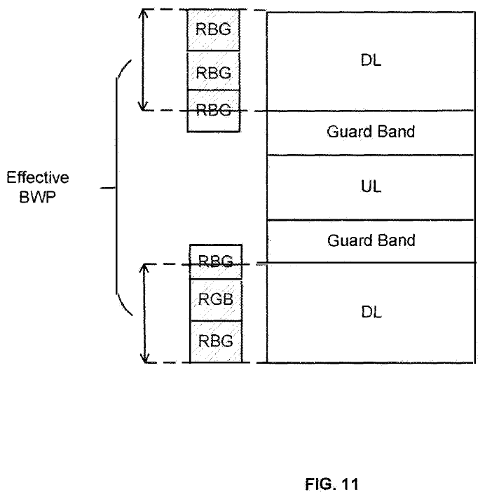

FIG. 11 illustrates frequency domain resource allocation for SBFD symbols where frequency resources used by UE to receive downlink transmissions are grouped into RBGs with a nominal RBG size determined based on an effective bandwidth that is the concatenation of the two DL frequency sub-bands, according to one aspect of the disclosure. The RBG at the edge of the lower DL frequency sub-band partially overlaps with the lower guard band. In this RBG, frequency resources that overlap with the lower guard band may be dropped so that the actual frequency resources used by the UE to receive downlink transmission in this RBG may be smaller than the nominal size of the RBG. Similarly, the RBG at the edge of the upper DL frequency sub-band partially overlaps with the upper guard band. In this RBG, frequency resources that overlap with the upper guard band may be dropped so that the actual frequency resources used by the UE to receive downlink transmission in this RBG may be smaller than the nominal size of the RBG.

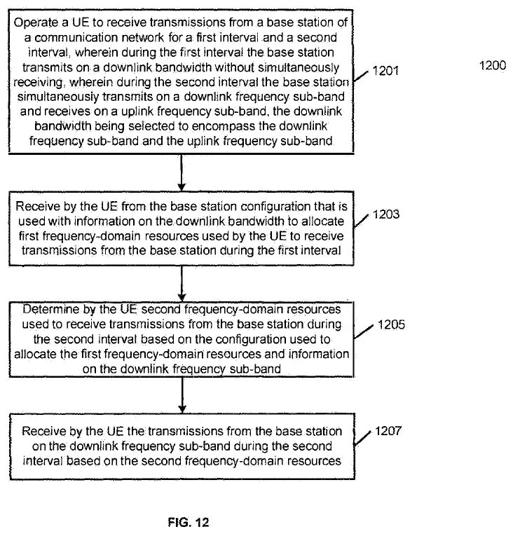

FIG. 12 depicts a flowchart of a method 1200 for a UE to receive downlink transmissions on frequency resources in SBFD symbols and non-SBFD symbols when the frequency resources are grouped and allocated differently for the SBFD and non-SBFD symbols, according to one aspect of the disclosure.

In operation 1201, the UE receives transmissions from a base station of a communication network in a first interval and a second interval. During the first interval, the base statin transmits on a downlink bandwidth without simultaneously receiving. During the second interval, the base station simultaneously transmits on a downlink frequency sub-band and receives on an uplink frequency sub-band. The downlink bandwidth is selected to encompass the downlink frequency sub-band and the uplink frequency sub-band.

In operation 1203, the UE receives from the base station configuration information that is used with information on the downlink bandwidth to allocate first frequency-domain resources used by the UE to receive transmissions from the base station during the first interval.

In operation 1205, the UE determines second frequency-domain resources used to receive transmissions from the base station during the second interval based on the configuration information used to allocate the first frequency-domain resources and information on the downlink frequency sub-band.

In operation 1207, the UE receives the transmissions from the base station on the downlink frequency sub-band during the second interval based on the second frequency-domain resources.

In one aspect, frequency resources for downlink data transmissions may be bundled to allow the UE to assume that all frequency resources within a bundle experience a similar propagation channel. For example, precoding resource block group (PRG) is a set of contiguous PRBs of frequency resources from which the UE may generate a single channel estimate. The resource blocks belonging to a PRG are assumed to experience similar channel conditions and have the same precoding applied by the base station. The nominal PRG size for non-SBFD symbols may take on values of 2, 4, or wideband in 5G.

In one embodiment, for PRB bundling of frequency resources used for downlink data transmissions within SBFD symbols, the nominal PRG size may be based on the size of both DL frequency sub-bands. For example, the nominal size of the PRG may be a function of the size of the concatenation of the two downlink frequency sub-bands, which may be considered an effective DL BWP for SBFD symbols, similar to the nominal RBG size in FDRA of DL frequency resource. As in RBG, PRG may not lie within the uplink frequency sub-band or the guard bands of SBFD symbols. In one embodiment, actual PRGs at the edge of the downlink frequency sub-bands may be smaller than the nominal PRG size so that the bundled resource blocks only lie within the downlink frequency sub-bands.

In one embodiment, the nominal PRG size may be based on the size of the downlink BWP as in non-SBFD symbols. Again, PRG may not lie within the uplink frequency sub-band or the guard bands of SBFD symbols. In one embodiment, actual PRGs at the edge of the downlink frequency sub-bands may be smaller than the nominal PRG size so that the bundled resource blocks only lie within the downlink frequency sub-bands.

In one aspect, UE may implement capabilities to respond to time-domain resources scheduled for transmitting uplink signals across SBFD and non-SBFD symbols. For example, the base station may schedule an uplink transmission occasion for UE to transmit uplink user data (e.g., physical uplink shared channel (PUSCH)), uplink control messages, (e.g., physical uplink control channel (PUCCH)), uplink reference signals used by the base station to measure uplink propagation channel (e.g., sounding reference signals (SRS)), random access request (physical random access channel (PRACH)), etc. The uplink transmission occasion within a time slot may span in time SBFD and non-SBFD symbols.

In one embodiment, all SBFD and non-SBFD symbols in the uplink transmission occasion may span the same frequency resources and UE may apply a single transmission power to all the symbols. In one embodiment, UE may be indicated by the base station to apply a different or reduced power on SBFD symbols to reduce cross-channel interference between multiple UEs transmitting over the uplink frequency sub-band. In one embodiment, UE may not expect the scheduled uplink transmission occasion to span in time both SBFD and non-SBFD symbols.

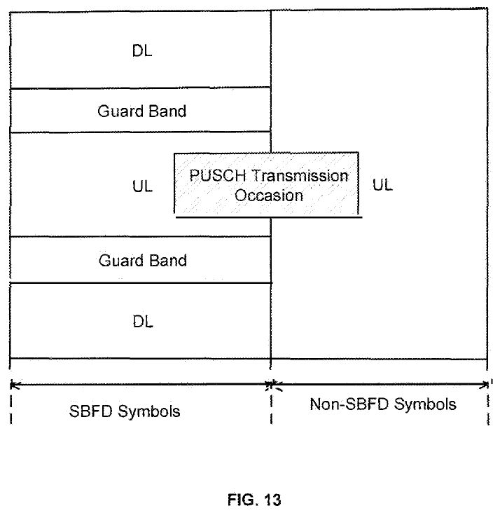

FIG. 13 illustrates a UE transmitting an uplink transmission (PUSCH) occasion that spans SBFD and non-SBFD symbols when all the symbols in the uplink transmission occasion spans the same frequency resources, according to one aspect of the disclosure. The UE may transmit PUSCH using frequency resources allocated from the uplink frequency sub-band of the SBFD symbols and the frequency resources allocated from the uplink BWP of the non-SBFD symbols.

In one aspect, UE may implement capabilities to respond to multiple repetitions of an uplink transmission occasion (e.g., PUSCH transmission) within a time slot or across multiple time slots when the multiple uplink transmission occasions include both SBFD symbols and non-SBFD symbols. In one embodiment, multiple uplink transmissions may arise when there are multi-grant PUSCH scheduled by a single DCI. In one embodiment, if the first uplink repetition occasion is scheduled within SBFD symbols and a subsequent uplink repetition occasion includes non-SBFD symbols, the UE may drop the subsequent uplink repetition occasion.

In one embodiment, if the first uplink repetition occasion is scheduled within SBFD symbols and a subsequent uplink repetition occasion includes non-SBFD uplink symbols or symbols that may be configured for uplink transmission, and if the uplink BWP of the non-SBFD symbols and the uplink frequency sub-band of the SBFD symbols have the same size, the UE may use the subsequent uplink repetition occasion subject to existing condition for transmitting non-SBFD uplink symbols. In one embodiment, if the first uplink repetition occasion is scheduled within SBFD symbols and a subsequent uplink repetition occasion includes non-SBFD uplink symbols or symbols that may be configured for uplink transmission, and if the allocated uplink frequency resources of the SBFD symbols fit within the uplink BWP of the non-SBFD symbols, the UE may use the subsequent uplink repetition occasion subject to existing condition for transmitting non-SBFD uplink symbols.

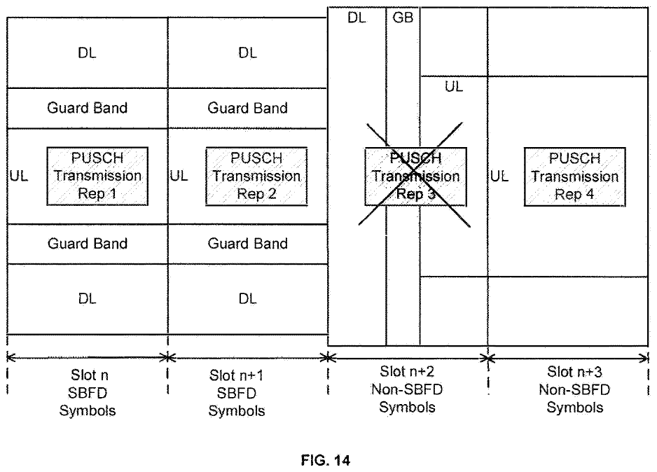

FIG. 14 illustrates a UE transmitting multiple repetitions of an uplink transmission occasion across multiple slots of SBFD symbols and non-SBFD symbols when the first uplink repetition occasion is scheduled in a slot of SBFD symbols and a subsequent uplink repetition occasion includes a slot of non-SBFD symbols, according to one aspect of the disclosure.

PUSCH transmission repetition 1 is scheduled within SBFD symbols of slot n. PUSCH transmission repetition 2 is scheduled within SBFD symbols of slot n+1. However, PUSCH transmission repetition 3 is scheduled within non-SBFD symbols of slot n+2. Because the PUSCH transmission repetition 3 as scheduled overlaps with the DL time portion and the guard band of the non-SBFD slot n+2, the UE may drop PUSCH transmission repetition 3. PUSCH transmission repetition 4 is scheduled within non-SBFD symbols of slot n+3. Because the allocated uplink frequency resources of the SBFD symbols fit within the uplink BWP of the non-SBFD symbols of slot n+3, the UE may transmit PUSCH transmission repetition 4.

In one embodiment, if the first uplink repetition occasion is scheduled within non-SBFD symbols and a subsequent uplink repetition occasion includes SBFD symbols, the UE may drop the subsequent repetition occasion. In one embodiment, if the first uplink repetition occasion is scheduled within non-SBFD symbols and a subsequent uplink repetition occasion includes SBFD symbols, and if the uplink BWP of the non-SBFD symbols and the uplink frequency sub-band of the SBFD symbols have the same size, the UE may use the subsequent uplink repetition occasion. In one embodiment, if the first uplink repetition occasion is scheduled within non-SBFD symbols and a subsequent uplink repetition occasion includes SBFD symbols, and if the uplink BWP of the non-SBFD symbols fit within the allocated uplink frequency resources of the SBFD symbols, the UE may use the subsequent repetition occasion. In one embodiment, an uplink repetition occasion of SBFD symbols within a slot may be transmitted using a different or reduced power relative to the transmission power of non-SBFD symbols.

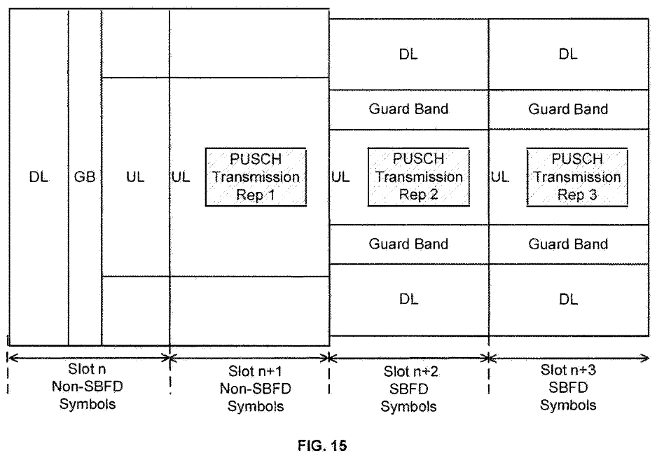

FIG. 15 illustrates a UE transmitting multiple repetitions of an uplink transmission occasion across multiple slots of SBFD symbols and non-SBFD symbols when the first uplink repetition occasion is scheduled in a slot of non-SBFD symbols and subsequent uplink repetition occasions include slots of non-SBFD symbols, according to one aspect of the disclosure.

PUSCH transmission repetition 1 is scheduled within non-SBFD symbols of slot n+1. PUSCH transmission repetition 2 is scheduled within SBFD symbols of slot n+2. PUSCH transmission repetition 3 is scheduled within SBFD symbols of slot n+3. Because the allocated frequency resources from the uplink BWP of the non-SBFD symbol of slot n+1 fit within the allocated uplink frequency sub-band of the SBFD symbols in slot n+2 and slot n+3, the UE may transmit PUSCH transmission repetitions 2 and 3.

In one aspect, the UE may implement capabilities to respond to time-domain resources scheduled for transmitting downlink signals across SBFD and non-SBFD symbols. For example, the base station may schedule a downlink transmission occasion for UE to receive downlink user data (e.g., PDSCH), downlink control messages (e.g., PDCCH), downlink reference signals (e.g., CSI-RS), etc. The downlink transmission occasion within a time slot may span in time SBFD and non-SBFD symbols.

In one embodiment, all SBFD and non-SBFD symbols in the downlink transmission occasion may span the same frequency resources. The UE may assume that the base station applies the same transmit power and the same number of antenna ports to transmit the SBFD and non-SBFD symbols, and that the downlink channels of the SBFD and non-SBFD symbols share common characteristic (e.g., all symbols are quasi co-located (QCLed)). In one embodiment, the base station may transmit the SBFD symbols using a different number of transmit radio units (TxRUs) (e.g., reduced TxRUs) and/or different (e.g., reduced) antenna gain in comparison to those for the non-SBFD symbols. In this embodiment, the UE may receive the downlink transmission occasion. In one embodiment, the UE may not expect the scheduled downlink transmission occasion to span in time both SBFD and non-SBFD symbols.

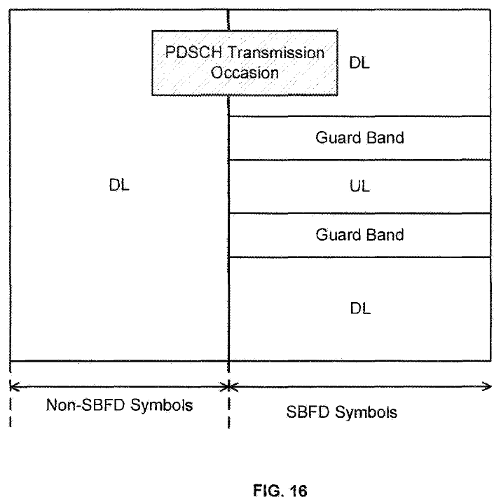

FIG. 16 illustrates a UE receiving a downlink transmission (PDSCH) occasion that spans SBFD and non-SBFD symbols when all the symbols in the downlink transmission occasion spans the same frequency resources, according to one aspect of the disclosure. The UE may receive PDSCH using frequency resources allocated from the downlink frequency sub-band of the SBFD symbols and the frequency resources allocated from the downlink BWP of the non-SBFD symbols.

In one aspect, UE may implement capabilities to respond to multiple repetitions of a downlink transmission (e.g., PDSCH transmission) occasion within a time slot or across multiple time slots when the multiple downlink transmission occasions include both SBFD symbols and non-SBFD symbols. In one embodiment, multiple downlink transmissions may arise when there are multi-grant PDSCH scheduled by a single DCI. In one embodiment, if the first downlink repetition occasion is scheduled within SBFD symbols and a subsequent downlink repetition occasion includes non-SBFD symbols, the UE may receive the subsequent repetition occasion subject to the condition the base station applies the same transmit power and the same number of antenna ports to transmit the SBFD and non-SBFD symbols, and that the downlink channels of the SBFD and non-SBFD symbols share common characteristics (e.g., all symbols are quasi co-located (QCLed)).

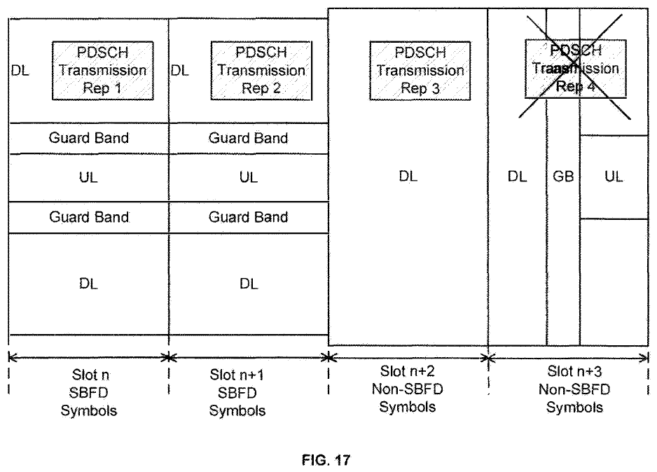

FIG. 17 illustrates a UE receiving multiple repetitions of a downlink transmission occasion across multiple slots of SBFD symbols and non-SBFD symbols when the first downlink link repetition occasion is scheduled in a slot of SBFD symbols and subsequent downlink repetition occasions include slots of non-SBFD symbols, according to one aspect of the disclosure.

PDSCH transmission repetition 1 is scheduled within SBFD symbols of slot n. PDSCH transmission repetition 2 is scheduled within SBFD symbols of slot n+1. PDSCH transmission repetition 3 is scheduled within non-SBFD symbols of slot n+2. Because the allocated downlink frequency resources of the SBFD symbols fit within the downlink BWP of the non-SBFD symbols of slot n+2, the UE may receive PDSCH transmission repetition 3. PDSCH transmission repetition 4 is scheduled within non-SBFD symbols of slot n+3. Because the PDSCH transmission repetition 4 as scheduled overlaps with the guard band and the UL time portion of the non-SBFD slot n+3, the UE may not receive PDSCH transmission repetition 3.

In one embodiment, if the first downlink repetition occasion is scheduled within non-SBFD symbols and a subsequent downlink repetition occasion includes non-SBFD symbols, the UE may drop the subsequent repetition occasion. In one embodiment, if the first downlink repetition occasion is scheduled within non-SBFD symbols and a subsequent downlink repetition occasion includes SBFD symbols, and if the allocated downlink frequency resources in the downlink BWP of the non-SBFD symbols fit within the downlink frequency sub-band of the SBFD symbols, the UE may receive the subsequent repetition occasion subject to the condition the base station applies the same transmit power and the same number of antenna ports to transmit the SBFD and non-SBFD symbols, and that the downlink channels of the SBFD and non-SBFD symbols share common characteristics (e.g., all symbols are quasi co-located (QCLed)).

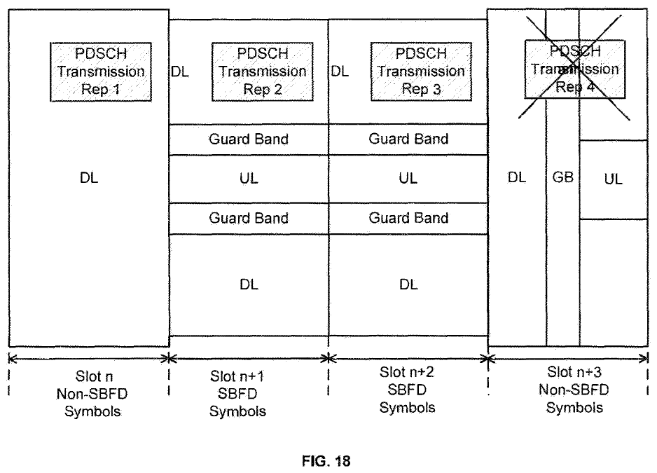

FIG. 18 illustrates a UE receiving multiple repetitions of a downlink transmission occasion across multiple slots of SBFD symbols and non-SBFD symbols when the first downlink link repetition occasion is scheduled in a slot of non-SBFD symbols and subsequent downlink repetition occasions include slots of SBFD symbols, according to one aspect of the disclosure.

PDSCH transmission repetition 1 is scheduled within non-SBFD symbols of slot n. PDSCH transmission repetition 2 is scheduled within SBFD symbols of slot n+1. PDSCH transmission repetition 3 is scheduled within SBFD symbols of slot n+2. Because the allocated frequency resources from the downlink BWP of the non-SBFD symbol of slot n fit within the allocated downlink frequency sub-band of the SBFD symbols in slot n+1 and slot n+2, the UE may receive PDSCH transmission repetitions 2 and 3. PDSCH transmission repetition 4 is scheduled within non-SBFD symbols of slot n+3. Because the PDSCH transmission repetition 4 as scheduled overlaps with the guard band and the UL time portion of the non-SBFD slot n+3, the UE may not receive PDSCH transmission repetition 3.

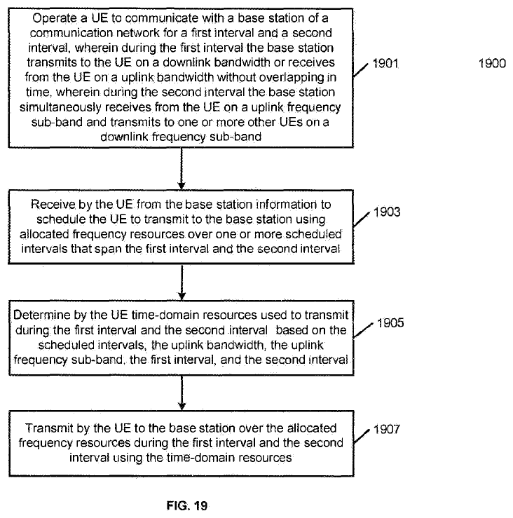

FIG. 19 depicts a flowchart of a method 1900 for a UE to transmit on uplink transmission occasions when the uplink transmission occasions include time and frequency resources allocated for transmitting SBFD and non-SBFD symbols, according to one aspect of the disclosure.

In operation 1901, the UE communicates with a base station of a communication network in a first interval and a second interval. During the first interval, the base station transmits to the UE on a downlink bandwidth or receives from the UE on an uplink bandwidth without overlapping in time. During the second interval, the base station simultaneously receives from the UE on an uplink frequency sub-band and transmits to one or more other UEs on a downlink frequency sub-band.

In operation 1903, the UE receives from the base station scheduling information to schedule the UE to transmit to the base station using allocated frequency resources over one or more scheduled intervals that span the first interval and the second interval.

In operation 1905, the UE determines time-domain resources used to transmit during the first interval and the second interval based on the scheduled intervals, the uplink bandwidth, the uplink frequency sub-band, the first interval, and the second interval.

In operation 1907, the UE transmits to the base station over the allocated frequency resources during the first interval and the second interval using the time-domain resources.

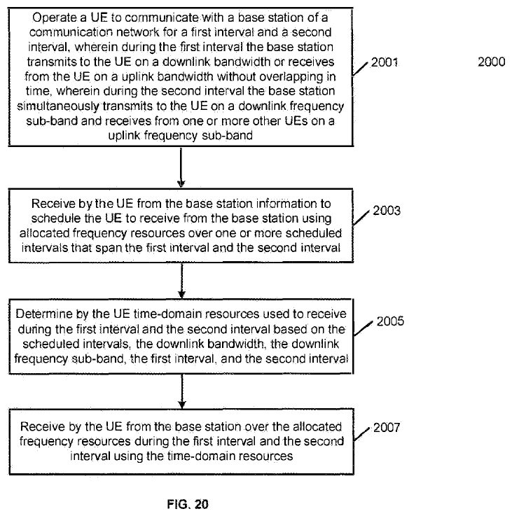

FIG. 20 depicts a flowchart of a method 2000 for a UE to receive on downlink transmission occasions when the downlink transmission occasions include time and frequency resources allocated for receiving SBFD and non-SBFD symbols, according to one aspect of the disclosure.

In operation 2001, the UE communicates with a base station of a communication network in a first interval and a second interval. During the first interval, the base station transmits to the UE on a downlink bandwidth or receives from the UE on an uplink bandwidth without overlapping in time. During the second interval, the base station simultaneously receives from the UE on an uplink frequency sub-band and transmits to one or more other UEs on a downlink frequency sub-band.

In operation 2003, the UE receives from the base station scheduling information to schedule the UE to receive from the base station using allocated frequency resources over one or more scheduled intervals that span the first interval and the second interval.

In operation 2005, the UE determines time-domain resources used to receive during the first interval and the second interval based on the scheduled intervals, the downlink bandwidth, the downlink frequency sub-band, the first interval, and the second interval.

In operation 2005, the UE receives from the base station over the allocated frequency resources during the first interval and the second interval using the time-domain resources.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

For example, the described operations may be stored as instructions on a non-transitory computer readable medium for execution by a computer. The computer may execute the instructions to communicate with a communication network (e.g., a base station) to enhance the reporting of precoding matrix information associated with fast changing channel response by independently selecting TD or DD basis vectors for different groupings of SD and FD basis vectors.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A baseband processor of a wireless user equipment (UE) of a communication network in communication with memory storing instructions that, when executed by the baseband processor, cause the baseband processor to perform operations comprising:
receiving transmissions from a base station of the communication network for a first interval and a second interval, wherein during the first interval the base station transmits on a downlink bandwidth without simultaneously receiving, wherein during the second interval the base station simultaneously transmits on a downlink frequency sub-band and receives on a uplink frequency sub-band, the downlink bandwidth being selected to encompass the downlink frequency sub-band and the uplink frequency sub-band;
receiving from the base station, frequency-domain configuration to configure the UE to receive reference signals transmitted by the base station during the first interval;
determining frequency-domain resources used to receive the reference signals during the second interval based on the frequency-domain configuration, information on the downlink bandwidth, and information on the downlink frequency sub-band; and
receiving the reference signals transmitted by the base station on the downlink frequency sub-band during the second interval based on the frequency-domain resources.

2. The baseband processor of claim 1, wherein the frequency-domain resources include two outer downlink frequency sub-bands each separated by a guard band from an inner uplink frequency sub-band.

3. The baseband processor of claim 1, wherein the frequency-domain configuration configures the UE with a number of ports parameter that comprises a value that is associated with time division duplex (TDD) symbols and a second value that is associated with sub-band full duplex (SBFD) symbols.

4. The baseband processor of claim 1, wherein the reference signals comprises a channel state information reference signal (CSI-RS) and the frequency-domain configuration configures a starting resource block (RB) of the CSI-RS within time division duplex (TDD) symbols.

5. The baseband processor of claim 3, wherein determining the frequency-domain resources comprises aligning the frequency-domain resources to receive downlink reference signals on one downlink frequency sub-band of SBFD symbols in response to the frequency-domain resources that are commonly configured between non-SBFD and SBFD symbols being in an uplink frequency sub-band or in a guard band.

6. A baseband processor of a wireless user equipment (UE) of a communication network in communication with memory storing instructions that, when executed by the baseband processor, cause the baseband processor to perform operations comprising:
receiving transmissions from a base station of the communication network for a first interval and a second interval, wherein during the first interval the base station transmits on a downlink bandwidth without simultaneously receiving, wherein during the second interval the base station simultaneously transmits on a downlink frequency sub-band and receives on a uplink frequency sub-band, the downlink bandwidth being selected to encompass the downlink frequency sub-band and the uplink frequency sub-band;
receiving from the base station, configuration with information on the downlink bandwidth to allocate first frequency-domain resources used by the UE to receive transmissions from the base station during the first interval;
determining second frequency-domain resources used to receive transmissions from the base station during the second interval based on the configuration used to allocate the first frequency-domain resources and information on the downlink frequency sub-band; and
receiving the transmissions from the base station on the downlink frequency sub-band during the second interval based on the second frequency-domain resources.

7. The baseband processor of claim 6, wherein determining the second frequency-domain resources comprises determining one or more precoding resource block group (PRGs) comprising contiguous precoding resource blocks (PRBs) that are each associated with a single channel estimate.

8. The baseband processor of claim 7, wherein a size of the one or more PRGs is determined based on a size of the downlink bandwidth.

9. The baseband processor of claim 8, wherein a first of the PRGs at an edge of the downlink frequency sub-band has a size that is smaller than a second of the PRGs not at the edge of the downlink frequency sub-band.

10. A baseband processor of a wireless user equipment (UE) of a communication network in communication with memory storing instructions that, when executed by the baseband processor, cause the baseband processor to perform operations comprising:
communicating with a base station of the communication network for a first interval and a second interval, wherein during the first interval the base station transmits to the UE on a downlink bandwidth or receives from the UE on an uplink bandwidth without overlapping in time, wherein during the second interval the base station simultaneously receives from the UE on an uplink frequency sub-band and transmits to one or more other UEs on a downlink frequency sub-band;
receiving from the base station, information to schedule the UE to transmit to the base station using allocated frequency resources over one or more scheduled intervals that span the first interval and the second interval;
determining time-domain resources used to transmit during the first interval and the second interval based on the one or more scheduled intervals, the uplink bandwidth, the uplink frequency sub-band, the first interval, and the second interval; and
transmitting to the base station over the allocated frequency resources during the first interval and the second interval using the time-domain resources.

11. The baseband processor of claim 10, wherein transmitting to the base station over the allocated frequency resources comprises transmitting multiple repetitions of an uplink transmission occasion across multiple slots of sub-band full-duplex (SBFD) symbols and non-SBFD symbols when a first uplink repetition occasion is scheduled in a slot of the SBFD symbols and a subsequent uplink repetition occasion includes a slot of the non-SBFD symbols.

12. The baseband processor of claim 11, wherein the first uplink repetition occasion comprises a PUSCH transmission repetition, and the subsequent uplink repetition occasion comprises a subsequent PUSCH transmission repetition that overlaps with a downlink time portion, and wherein the UE drops the subsequent PUSCH transmission repetition.

13. The baseband processor of claim 11, wherein in response to the first uplink repetition occasion being scheduled within the non-SBFD symbols and the subsequent uplink repetition occasion includes the SBFD symbols, the UE drops the subsequent repetition occasion.

14-19. (canceled)
